(19) United States
(12) Patent Application Publication
(10) Pub. No.: US 2026/0254938 A1
(43) Pub. Date: Aug. 27, 2026

(54) Display with Spread Spectrum Driven Tint Layer

(71) Applicant: Apple Inc., Cupertino, CA (US)

(72) Inventors: Youngbae Son, San Jose, CA (US); Shengchang Cai, Belmont, CA (US)

(21) Appl. No.: 19/543,462

(22) Filed: Feb. 18, 2026

Related U.S. Application Data
(60) Provisional application No. 63/761,564, filed on Feb. 21, 2025.

(51) Int. Cl. H04N 13/398; H04N 13/344; H04N 13/383

(52) U.S. Cl. CPC H04N 13/398; H04N 13/344; H04N 13/383; H04N 2213/008

(57) ABSTRACT

A display may include a waveguide that propagates image light. An optical coupler may redirect the image light towards an eye box. A tint layer may transmit environmental light to the eye box through the coupler. A driver may supply a drive signal to the tint layer that places the tint layer in a steady state. The drive signal may include a binary square wave at a first frequency. The driver may vary the first frequency over time while the tint layer is in the steady state. The driver may vary the first frequency through a set of N different frequencies over time randomly or according to a predetermined schedule. Varying the first frequency may serve to mitigate flickering in the environmental light transmitted by the tint layer, such as in situations where the environmental light includes intensity modulations at a second frequency susceptible to beating with the first frequency.

This application claims the benefit of U.S. Provisional Patent Application No. 63/761,564, filed February 21, 2025, which is hereby incorporated by reference herein in its entirety.

### FIELD

This relates generally to electronic devices, including electronic devices with displays such as head-mounted devices.

### BACKGROUND

Electronic devices such as head-mounted devices can include near-eye displays for presenting virtual content to a user. It can be challenging to design a head-mounted device with near-eye displays that present virtual content to eye boxes for view by the user. If care is not taken, virtual content presented by the displays can be washed out by environmental light and/or light presented to the eye boxes can include unsightly or distracting visible artifacts.

### SUMMARY

An electronic device such as a head-mounted device may include a waveguide that propagates image light. An optical coupler on the waveguide may redirect the image light out of the waveguide and towards an eye box. An electrically adjustable tint layer may overlap the optical coupler. The tint layer may transmit environmental light to the eye box through the optical coupler. The optical coupler may serve as an optical combiner for the image light and the environmental light.

A driver may supply a drive signal to the tint layer to place the tint layer in a desired steady state. The drive signal may include a binary square wave at a first frequency. Situations may arise when the environmental light includes light with intensity modulations at a second frequency. The driver may vary the first frequency of the drive signal over time while the tint layer is in the steady state. The driver may vary the first frequency through a set of N different frequencies over time while the tint layer is in the steady state. The driver may switch between the N different frequencies randomly or according to a predetermined hopping schedule. By varying the first frequency in this way, the driver may remove, from the environmental light provided to the eye box, any unsightly flicker artifacts associated with beating between the first frequency and the second frequency.

### BRIEF DESCRIPTION OF THE DRAWINGS

FIG. 1 is a diagram of an illustrative system having a display in accordance with some embodiments.

FIG. 2 is a top view of an illustrative optical system for a display having a waveguide with a tint layer for providing a virtual object overlaid with a real-world object to an eye box in accordance with some embodiments.

FIG. 3 is a front view of an illustrative tint layer in accordance with some embodiments.

FIG. 4 is a state diagram showing illustrative steady states of a display having a tint layer in accordance with some embodiments.

FIG. 5 is a cross-sectional top view of an illustrative tint layer driven by a spread spectrum drive signal in accordance with some embodiments.

FIG. 6 is a timing diagram showing how an illustrative spread spectrum drive signal may mitigate the production of flicker artifacts in environmental light displayed at an eye box in accordance with some embodiments.

FIG. 7 is a timing diagram illustrating one example of how the frequency of an illustrative spread spectrum drive signal may vary over time in accordance with some embodiments.

FIG. 8 is a frequency diagram of an illustrative spread spectrum drive signal in accordance with some embodiments.

FIG. 9 is a circuit diagram of an illustrative driver for a tint layer in accordance with some embodiments.

FIG. 10 is a circuit diagram of an illustrative spread spectrum generator in a driver for a tint layer in accordance with some embodiments.

FIG. 11 is a timing diagram of an illustrative spread spectrum drive signal for a tint layer in accordance with some embodiments.

FIG. 12 is a flow chart of illustrative steps involved in operating a display having a tint layer driven by a spread spectrum drive signal in accordance with some embodiments.

### DETAILED DESCRIPTION

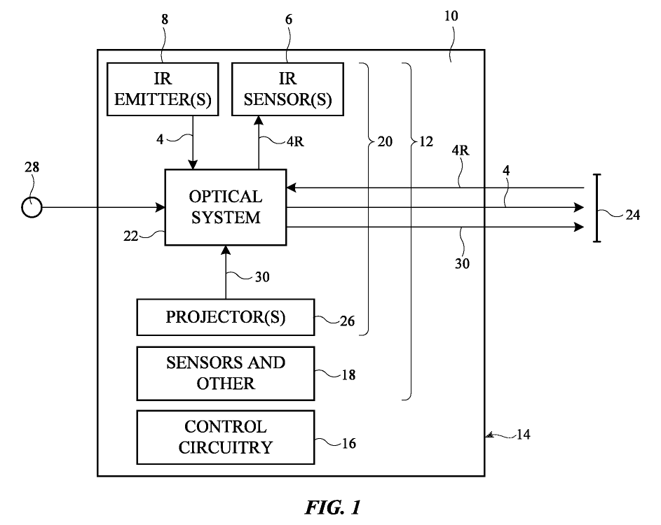

System 10 of FIG. 1 may be an electronic device such as a head-mounted device having one or more displays. System 10 may sometimes also be referred to herein as device 10. The displays in system 10 may include near-eye displays 20 mounted within support structure such as housing 14. Housing 14 may have the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 may include one or more display projectors such as projectors 26 (sometimes referred to herein as display modules 26) and one or more optical systems such as optical systems 22. Projectors 26 may be mounted in a support structure such as housing 14. Each projector 26 may emit image light 30 that is redirected towards a user’s eyes at eye box 24 using an associated one of optical systems 22. Image light 30 may be, for example, visible light (e.g., including wavelengths from 400-700 nm) that contains and/or represents something viewable such as a scene or object (e.g., as modulated onto the image light using the image data provided by the control circuitry to the display module).

The operation of system 10 may be controlled using control circuitry 16. Control circuitry 16 may include storage and processing circuitry for controlling the operation of system 10. Control circuitry 16 may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 may include one or more processors (e.g., microprocessors, microcontrollers, digital signal processors, baseband processors, etc.), power management units, audio chips, graphics processing units, application specific integrated circuits, and other integrated circuits. Software code may be stored on storage in control circuitry 16 and run on processing circuitry in control circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted system 10 with user input. Input-output devices 12 may also be used to gather information on the environment in which system 10 (e.g., head-mounted system 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.).

Projectors 26 may include liquid crystal displays, organic light-emitting diode displays, laser-based displays, or displays of other types. Projectors 26 may include light sources, emissive display panels (e.g., uLED panels), transmissive display panels that are illuminated with illumination light from light sources to produce image light, reflective display panels such as digital micromirror display (DMD) panels and/or liquid crystal on silicon (LCOS) display panels that are illuminated with illumination light from light sources to produce image light 30, etc.

Optical systems 22 may form lenses that allow a viewer (see, e.g., a viewer’s eyes at eye box 24) to view images on display(s) 20. There may be two optical systems 22 (e.g., for forming left and right lenses) associated with respective left and right eyes of the user. A single display 20 may produce images for both eyes or a pair of displays 20 may be used to display images. In configurations with multiple displays (e.g., left and right eye displays), the focal length and positions of the lenses formed by system 22 may be selected so that any gap present between the displays will not be visible to a user (e.g., so that the images of the left and right displays overlap or merge seamlessly).

If desired, optical system 22 may contain components (e.g., an optical combiner formed from reflective components, diffractive components, a waveguide, a direct view optical combiner, etc.) to allow real-world light (sometimes referred to as world light, scene light, environmental light, external light, or ambient light) from real-world (external) objects such as real-world (external) object 28 to be combined optically with virtual (computer-generated) images such as virtual images in image light 30. In this type of system, which is sometimes referred to as an augmented reality (AR) system, a user of system 10 may view both real-world content (e.g., world light from object 28) and computer-generated content that is overlaid on top of the real-world content. Camera-based augmented reality systems may also be used in system 10 (e.g., in an arrangement in which a camera captures real-world images of object 28 and this content is digitally merged with virtual content at optical system 22).

This example is illustrative and non-limiting. In other implementations, system 10 may be a virtual reality (VR) display, a mixed reality (MR) display, or an extended reality (XR) display. In these implementations, if desired, one or more cameras may capture images of environmental light from real-world object 28 and may display images of the environmental light at eye box 24 (e.g., overlaid with virtual content in image light 30). If desired, the camera(s) may capture images of the environmental light before or after the environmental light has passed through a tint layer as described herein. Implementations in which system 10 is an AR system are described herein as an example. Eye box 24 may represent a spatial surface (e.g., a planar or curved surface) that forms the nominal viewing area for the image light 30 displayed by optical system 22. Eye box 24 may be at a predetermined distance (e.g., a nominal eye relief) from optical system 22. Eye box 24 may have a predetermined angular size (e.g., an eye box field of view (FOV)) at the predetermined distance (e.g., where optical system 22 fills the spatial surface of eye box 24 at the predetermined distance with image light 30). Optical system 22 may, for example, focus image light 30 onto eye box 24 across the FOV of the eye box (e.g., the predetermined distance may be associated with the focal length of optical system 22 in directing image light 30 in the -Y direction). There need not be any physical structures in system 10 at or around the location of eye box 24 (e.g., eye box 24 may represent a logical or mathematical spatial surface in free space at the user-facing side of system 10). Alternatively, if desired, system 10 may include viewport structures, an eyepiece, optical alignment structures, eye-receiving structures, a light curtain or shroud, and/or other structures at and around eye box 24 (e.g., to serve as a guide for the user to easily and comfortably place their eye at and/or overlapping the spatial surface of eye box 24).

During operation, control circuitry 16 may supply image content to display 20. The content may be remotely received (e.g., from a computer or other content source coupled to system 10) and/or may be generated by control circuitry 16 (e.g., text, other computer-generated content, etc.). The content that is supplied to display 20 by control circuitry 16 may be viewed by a viewer (e.g., a user) at eye box 24. Input-output devices 12 may, if desired, include wireless communications circuitry and/or other circuitry to support communications with a computer or other external equipment (e.g., a computer that supplies display 20 with image content). Wireless communications circuitry in input-output devices 12 may include antennas, radio-frequency transceiver circuitry, and other wireless communications circuitry. Input-output devices 12 may include wired communications circuitry if desired. Wireless and/or wired communications circuitry in input-output devices 12 may support bidirectional wireless communications between system 10 and external equipment (e.g., a companion device such as a computer, cellular telephone, or other electronic device, an accessory such as a point device or a controller, computer stylus, or other input device, speakers or other output devices, etc.) over a wireless and/or wired link.

Wireless communication circuitry in input-output devices 12 may, for example, include radio-frequency transceiver circuitry such as wireless local area network transceiver circuitry configured to support communications over a wireless local area network link, near-field communications transceiver circuitry configured to support communications over a near-field communications link, cellular telephone transceiver circuitry configured to support communications over a cellular telephone link, or transceiver circuitry configured to support communications over any other suitable wired or wireless communications link. Wireless communications may, for example, be supported over a Bluetooth® link, a Wi-Fi® link, a wireless link operating at a frequency between 10 GHz and 400 GHz, a 60 GHz link, a cellular telephone link (e.g., a 4G link, a 5G link, a 6G link at sub-THz frequencies between around 100 GHz and around 10 THz, etc.), a wireless local area network WLAN) link, or another millimeter wave link, or another wireless communications link. System 10 may, if desired, include power circuits for transmitting and/or receiving wired and/or wireless power. For example, system 10 may include a coil and rectifier to receive wireless power that is provided to circuitry in system 10.

If desired, system 10 may include an optical sensor. The optical sensor may be used to gather optical sensor data associated with a user’s eyes at eye box 24. The optical sensor may, for example, be a gaze tracking sensor that gathers optical sensor data such as gaze image data (gaze tracking image data or gaze tracking sensor data) from a user’s eye at eye box 24. Control circuitry 16 may process the optical sensor data to identify and track the direction of the user’s gaze in real time. Control circuitry 16 may perform any desired operations based on the tracked direction of the user’s gaze over time.

As shown in FIG. 1, the optical sensor (gaze tracking sensor) may include one or more optical emitters such as infrared emitter(s) 8 and one or more optical receivers (sensors) such as infrared sensor(s) 6 (sometimes referred to herein as optical sensor 6). Infrared emitter(s) 8 may include one or more light sources that emit sensing light such as light 4. Light 4 may be used for performing optical sensing on/at eye box 24 (e.g., gaze tracking) rather than conveying pixels of image data such as in image light 30. Light 4 may include infrared light. The infrared light may be at infrared (IR) wavelengths and/or near-infrared (NIR) wavelengths (e.g., any desired wavelengths from around 700 nm to around 15 microns). Light 4 may additionally or alternatively include wavelengths less than 700 nm if desired. Light 4 may sometimes be referred to herein as sensor light 4.

Infrared emitter(s) 8 may direct light 4 towards optical system 22. Optical system 22 may direct the light 4 emitted by infrared emitter(s) 8 towards eye box 24. Light 4 may reflect off portions (regions) of the user’s eye at eye box 24 as reflected light 4R (sometimes referred to herein as reflected sensor light 4R, which is a reflected version of light 4). Optical system 22 may receive reflected light 4R and may direct reflected light 4R towards infrared sensor(s) 6. Infrared sensor(s) 6 may receive reflected light 4R from optical system 22 and may gather (e.g., generate, measure, sense, produce, etc.) optical sensor data in response to the received reflected light 4R. Infrared sensor(s) 6 may include an image sensor or camera (e.g., an infrared image sensor or camera), for example. Infrared sensor(s) 6 may include, for example, one or more image sensor pixels (e.g., arrays of image sensor pixels). The optical sensor data may include image sensor data (e.g., image data, infrared image data, one or more images, etc.). Infrared sensor(s) 6 may pass the optical sensor data to control circuitry 16 for further processing. Infrared sensor(s) 6 and infrared emitter(s) 8 may be omitted if desired.

It may be desirable to monitor the user’s eyes while the user’s eyes are located in eye boxes 24. For example, it may be desirable to use a camera (e.g., IR sensor(s) 6) to capture images of the user’s irises (or other portions of the user’s eyes) for user authentication. It may also be desirable to monitor the position of the user’s eyes at eye boxes 24. This may include monitoring the direction of the user’s gaze (sometimes also referred to herein as gaze direction) and/or monitoring the spatial location of the user’s pupils. A gaze tracking sensor in system 10 may measure the position of the user’s eyes at eye boxes 24 over time. The gaze tracking sensor may generate gaze tracking information (sometimes also referred to herein as eye position information) that identifies, includes, or characterizes the position of the user’s eyes at eye boxes 24. As other examples, the gaze tracking information may be used as a form of user input and/or may be used to determine where, within an image, image content resolution should be locally enhanced in a foveated imaging system.

Sensors in components 18 may include force sensors (e.g., strain gauges, capacitive force sensors, resistive force sensors, etc.), audio sensors such as microphones, touch and/or proximity sensors such as capacitive sensors such as a touch sensor that forms a button, trackpad, or other input device), and other sensors. If desired, sensors in components 18 may include optical sensors such as optical sensors that emit and detect light, ultrasonic sensors, optical touch sensors, optical proximity sensors, and/or other touch sensors and/or proximity sensors, monochromatic and color ambient light sensors, image sensors (e.g., cameras), fingerprint sensors, iris scanning sensors, retinal scanning sensors, and other biometric sensors, temperature sensors, sensors for measuring three-dimensional non-contact gestures (“air gestures”), pressure sensors, sensors for detecting position, orientation, and/or motion of system 10 and/or information about a pose of a user’s head (e.g., motion sensors such as accelerometers, magnetic sensors such as compass sensors, gyroscopes, and/or inertial measurement units that contain some or all of these sensors), health sensors such as blood oxygen sensors, heart rate sensors, blood flow sensors, and/or other health sensors, radio-frequency sensors, three-dimensional camera systems such as depth sensors (e.g., structured light sensors and/or depth sensors based on stereo imaging devices that capture three-dimensional images) and/or optical sensors such as self-mixing sensors and light detection and ranging (lidar) sensors that gather time-of-flight measurements (e.g., time-of-flight cameras), humidity sensors, moisture sensors, gaze tracking sensors, electromyography sensors to sense muscle activation, facial sensors, and/or other sensors. In some arrangements, system 10 may use sensors in components 18 and/or other input-output devices to gather user input. For example, buttons may be used to gather button press input, touch sensors overlapping displays can be used for gathering user touch screen input, touch pads may be used in gathering touch input, microphones may be used for gathering audio input (e.g., voice commands), accelerometers may be used in monitoring when a finger contacts an input surface and may therefore be used to gather finger press input, etc.

If desired, system 10 may include additional components (see, e.g., other components in components 18). The additional components may include haptic output devices, actuators for moving movable housing structures, audio output devices such as speakers, light-emitting diodes for status indicators, light sources such as light-emitting diodes that illuminate portions of a housing and/or display structure, other optical output devices, and/or other circuitry for gathering input and/or providing output. System 10 may also include a battery or other energy storage device, connector ports for supporting wired communication with ancillary equipment and for receiving wired power, and other circuitry.

Display(s) 20 can be used to present a variety of content to a user’s eye. The left and right displays 20 that are used to present a fused stereoscopic image to the user’s eyes when viewing through eye boxes 24 can sometimes be referred to collectively as a display 20. As an example, virtual reality (VR) content can be presented by display 20. Virtual reality content may refer to content that only includes virtual content (e.g., virtual objects) within a virtual reality (computer-generated) environment. As another example, mixed reality (MR) content can be presented by display 20. Mixed reality content may refer to content that includes virtual objects and real objects from the real-world physical environment in which device 10 is being operated (see, e.g., real-world objects 28 of FIG. 1). As another example, only real-world content may be presented by display 20. The real-world content may refer to images being captured by one or more front-facing cameras (e.g., cameras in components 18) and passed through as a live feed to the user. The real-world content being captured by the front-facing cameras is therefore sometimes referred to as a camera passthrough feed, a (live) video passthrough feed, or a passthrough video feed (stream). Implementations in which display 20 forms an AR display are described herein as a non-limiting example.

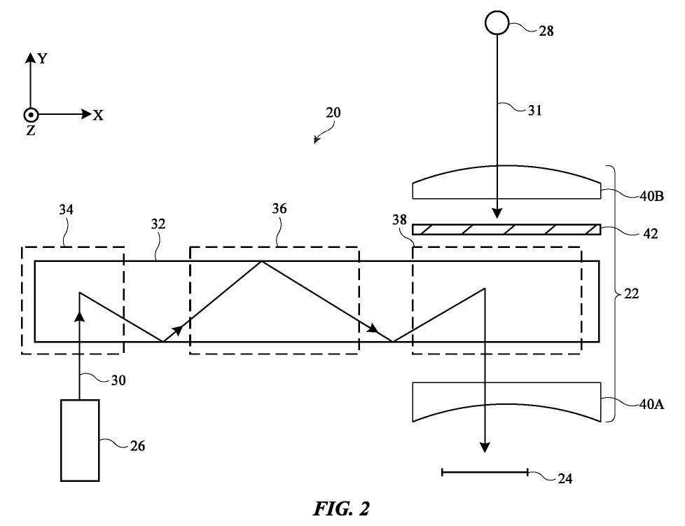

FIG. 2 is a top view of an illustrative display 20 that may be used in system 10 of FIG. 1 (e.g., in an AR configuration for system 10). As shown in FIG. 2, display 20 may include a projector such as projector 26 and an optical system such as optical system 22. Optical system 22 may include optical elements such as one or more waveguides 32. Waveguide 32 may include one or more stacked substrates (e.g., stacked planar and/or curved layers sometimes referred to herein as waveguide substrates) of optically transparent material such as plastic, polymer, glass, etc.

If desired, waveguide 32 may also include one or more layers of holographic recording media (sometimes referred to herein as holographic media, grating media, or diffraction grating media) on which one or more diffractive gratings are recorded (e.g., holographic phase gratings, sometimes referred to herein as holograms, surface relief gratings, etc.). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating medium may include photopolymers, gelatin such as dichromated gelatin, silver halides, holographic polymer dispersed liquid crystal, or other suitable holographic media.

Diffractive gratings on waveguide 32 may include holographic phase gratings such as volume holograms or thin-film holograms, meta-gratings, or any other desired diffractive grating structures. The diffractive gratings on waveguide 32 may also include surface relief gratings (SRGs) formed on one or more surfaces of the substrates in waveguide 32 (e.g., as modulations in thickness of a SRG medium layer) or gratings formed from metamaterials or metasurfaces. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles). Other light redirecting elements such as louvered mirrors may be used in place of diffractive gratings in waveguide 32 if desired.

As shown in FIG. 2, projector 26 may generate (e.g., produce and emit) image light 30 associated with image content to be displayed to eye box 24 (e.g., image light 30 may convey a series of image frames for display at eye box 24). Image light 30 may be collimated using a collimating lens in projector 26 if desired. Optical system 22 may be used to present image light 30 output from projector 26 to eye box 24. If desired, projector 26 may be mounted within support structure 14 of FIG. 1 whereas optical system 22 may be mounted between portions of support structure 14 (e.g., to form a lens that aligns with eye box 24). Other mounting arrangements may be used, if desired.

Optical system 22 may include one or more optical couplers (e.g., light redirecting elements) such as input coupler 34, cross-coupler 36, and output coupler 38. In the example of FIG. 2, input coupler 34, cross-coupler 36, and output coupler 38 are formed at or on waveguide 32. Input coupler 34, cross-coupler 36, and/or output coupler 38 may be completely embedded within the substrate layers of waveguide 32, may be partially embedded within the substrate layers of waveguide 32, may be mounted to waveguide 32 (e.g., mounted to an exterior surface of waveguide 32), etc.

Waveguide 32 may guide image light 30 down its length via total internal reflection. Input coupler 34 may be configured to couple image light 30 from projector 26 into waveguide 32 (e.g., within a total-internal reflection (TIR) range of the waveguide within which light propagates down the waveguide via TIR), whereas output coupler 38 may be configured to couple image light 30 from within waveguide 32 (e.g., propagating within the TIR range) to the exterior of waveguide 32 and towards eye box 24 (e.g., at angles outside of the TIR range). Input coupler 34 may include an input coupling prism, an edge or face of waveguide 32, a lens, a steering mirror or liquid crystal steering element, diffractive grating structures (e.g., volume holograms, SRGs, etc.), partially reflective structures (e.g., louvered mirrors), or any other desired input coupling elements.

As an example, projector 26 may emit image light 30 in direction +Y towards optical system 22. When image light 30 strikes input coupler 34, input coupler 34 may redirect image light 30 so that the light propagates within waveguide 32 via total internal reflection towards output coupler 38 (e.g., in direction +X within the TIR range of waveguide 32). When image light 30 strikes output coupler 38, output coupler 38 may redirect image light 30 out of waveguide 32 towards eye box 24 (e.g., back along the Y-axis). In implementations where cross-coupler 36 is formed on waveguide 32, cross-coupler 36 may redirect image light 30 in one or more directions as it propagates down the length of waveguide 32 (e.g., towards output coupler 38 from a direction of propagation as coupled into the waveguide by the input coupler). In redirecting image light 30, cross-coupler 36 may also perform pupil expansion on image light 30 in one or more directions. In expanding pupils of the image light, cross-coupler 36 may, for example, help to reduce the vertical size of waveguide 32 (e.g., in the Z direction) relative to implementations where cross-coupler 36 is omitted. Cross-coupler 36 may therefore sometimes also be referred to herein as pupil expander 36 or optical expander 36. If desired, output coupler 38 may also expand image light 30 upon coupling the image light out of waveguide 32.

Input coupler 34, cross-coupler 36, and/or output coupler 38 may be based on reflective and refractive optics or may be based on diffractive (e.g., holographic) optics. In arrangements where couplers 34, 36, and 38 are formed from reflective and refractive optics, couplers 34, 36, and 38 may include one or more reflectors (e.g., an array of micromirrors, partial mirrors, louvered mirrors, or other reflectors). In arrangements where couplers 34, 36, and 38 are based on diffractive optics, couplers 34, 36, and 38 may include diffractive gratings (e.g., volume holograms, surface relief gratings, etc.).

The example of FIG. 2 is illustrative and non-limiting. Optical system 22 may include multiple waveguides that are laterally and/or vertically stacked with respect to each other. Each waveguide may include one, two, all, or none of couplers 34, 36, and 38. Waveguide 32 may be at least partially curved or bent if desired. One or more of couplers 34, 36, and 38 may be omitted. If desired, optical system 22 may include a single optical coupler that performs the operations of both cross-coupler 36 and output coupler 38 (sometimes referred to herein as an interleaved coupler, a diamond coupler, or a diamond expander) or cross-coupler 36 may be separate from output coupler 38.

The operation of optical system 22 on image light 30 is shown in FIG. 2. Optical system 22 may also direct light 4 from infrared emitter(s) 8 towards eye box 24 and may direct reflected light 4R from eye box 24 towards infrared sensor(s) 6 (FIG. 1). In addition, output coupler 38 may form an optical combiner for image light 30 and environmental light 31 from real-world objects such as real-world (external) object 28. Environmental light 31 is sometimes also referred to herein as world light 31, scene light 31, external light 31, or ambient light 31. Environmental light 31 may include artificial light (e.g., emitted by real-world objects 28 such as light sources, emitters, and/or displays) and/or natural light (e.g., emitted by the sun, blackbody radiators, and/or other natural emitters or light sources and received at system 10 directly or via reflection off one or more surfaces and/or real-world objects 28). As shown in FIG. 2, environmental light 31 from real-world object 28 may pass through output coupler 38, which transmits the world light (e.g., without diffracting the world light) to eye box 24.

Image light 30 may include images of virtual objects, sometimes referred to herein as virtual object images or simply as virtual objects. Projector 26 may receive image data that includes the virtual object images (e.g., pixels of image data at different pixel locations that form the virtual object images). Output coupler 38 may serve to overlay (optically combine) the virtual object images with environmental light 31 from real-world object 28 within the field of view (FOV) of eye box 24. The control circuitry for system 10 may provide image data to projector 26 that places the virtual object images at desired locations within the FOV at eye box 24 (e.g., such that the virtual object images are overlaid with desired real-world objects in the scene/environment in front of system 10.)

Optical system 22 may include one or more lenses 40 that overlap output coupler 38. For example, optical system 22 may include at least a first lens 40A and a second lens 40B. Lens 40B may be interposed between waveguide 32 and real-world object 28. Lens 40A may be interposed between waveguide 32 and eye box 24. Lenses 40 are transparent and allow environmental light from real-world object 28 to pass to eye box 24 for viewing by the user. At the same time, the user can view virtual object images directed out of waveguide 32 and through lens 40A to eye box 24. Lenses 40A and 40B may sometimes also be referred to herein as lens elements.

The strength (sometimes referred to as the optical power, power, or diopter) of lens 40A can be selected to place virtual object images in image light 30 at a desired image distance (depth) from eye box 24 (sometimes referred to herein as a virtual object distance, virtual object image distance, virtual image distance (VID), virtual object depth, virtual image depth, or image depth). For example, it may be desirable to place virtual objects (virtual object images) such as text, icons, moving images, characters, effects, or other content or features at a certain virtual image distance (e.g., to integrate the virtual object image within, onto, into, or around the real-world objects in front of system 10). The placement of the virtual object at that distance can be accomplished by appropriate selection of the strength of lens 40A. Lens 40A may be a negative lens for users whose eyes do not have refraction errors. The strength (larger net negative power) of lens 40A can therefore be selected to adjust the distance (depth) of the virtual object. Lens 40A may therefore sometimes be referred to herein as bias lens 40A or bias- (B-) lens 40A.

If desired, lens 40B may have a complementary power value (e.g., a positive power with a magnitude that matches the magnitude of the negative power of lens 40A). Lens 40B may therefore sometimes be referred to herein as bias+ (B+) lens 40B, complementary lens 40B, or compensation lens 40B. For example, if lens 40A has a power of -2.0 diopter, lens 40B may have an equal and opposite power of +2.0 diopter (as an example). In this type of arrangement, the positive power of lens 40B cancels the negative power of lens 40A. As a result, the overall power of lenses 40A and 40B taken together will be 0 diopter. This allows a viewer to view real-world objects such as real-world object 28 without optical influence from lenses 40A and 40B. For example, a real-world object 28 located far away from system 10 (effectively at infinity) may be viewed as if lenses 40A and 40B were not present.

For a user with satisfactory uncorrected vision, this type of complementary lens arrangement therefore allows virtual objects to be placed in close proximity to the user (e.g., at a virtual image distance of 0.5-5 m, at least 0.1 m, at least 1 m, at least 2 m, less than 20 m, less than 10 m, less than 5 m, or other suitable near-to-midrange distance from device 10 while simultaneously allowing the user to view real world objects without modification by the optical components of the optical system). For example, a real-world object located at a distance of 2 m from device 10 (e.g., a real-world object being labeled by a virtual text label at a virtual image distance of 2 m) will optically appear to be located 2 m from device 10. This is merely illustrative and, if desired, lenses 40A and 40B need not be complementary lenses (e.g., lenses 40A and 40B may have any desired optical powers).

In addition, some users may require vision correction. Vision correction may be provided using tunable lenses, fixed (e.g., removable) lenses (sometimes referred to as supplemental lenses, vision correction lenses, removable lenses, or clip-on lenses), and/or by adjusting the optical power of lens 40A and/or lens 40B to implement the desired vision correction. In general, the vision correction imparted to the lens(es) may include corrections for ametropia (eyes with refractive errors) such as lenses to correct for nearsightedness (myopia), corrections for farsightedness (hyperopia), corrections for astigmatism, corrections for skewed vision, corrections to help accommodate age-related reductions in the range of accommodation exhibited by the eyes (sometimes referred to as presbyopia), and/or other vision disorders.

Lenses 40A and 40B may be provided with any desired optical powers and any desired shapes (e.g., may be plano-convex lenses, plano-concave lenses, plano-freeform lenses, freeform-convex lenses, freeform-concave lenses, convex-concave lenses, freeform-freeform lenses, etc.). Implementations in which the optical power(s) of lenses 40A and/or 40B are fixed (e.g., upon manufacture) are described herein as an example. If desired, one or both of lenses 40A and/or 40B may be electrically adjustable to impart different optical powers or power profiles over time (e.g., lenses 40A and/or 40B may be adjustable/tunable liquid crystal lenses).

In some operating conditions, such as when system 10 is operated outdoors, in rooms with bright lighting, or in other environments having relatively high light levels, environmental light from real-world objects 28 can overpower or wash out virtual objects presented to eye box 24 in image light 30, thereby limiting the contrast and visibility of the virtual objects when viewed at eye box 24. To reduce the brightness of the environmental light and maximize the contrast of the images (virtual objects) in image light 30 when viewed at eye box 24, optical system 22 may include a light-absorbing layer such as tint layer 42 (e.g., at an outward or world facing side of waveguide 32 and/or optical system 22). Tint layer 42 may be disposed within the optical path between real-world objects 28 and output coupler 38. The environmental light 31 from real-world objects 28 may pass through tint layer 42 prior to reaching eye box 24 (e.g., tint layer 42 may transmit the world light without transmitting image light 30). Tint layer 42 may absorb some of the real-world light, thereby reducing its brightness and increasing the contrast of virtual objects in image light 30 at eye box 24. If desired, the tint layer may also function to absorb real-world light even when the virtual image is turned off, performing a function like switchable sunglasses.

Tint layer 42 may be optically and/or physically interposed between lens 40B and waveguide 32 (as shown in FIG. 2, such that environmental light 31 is transmitted by lens 40B to tint layer 42, which transmits the world light to output coupler 38). Alternatively, lens 40B may be interposed between tint layer 42 and output coupler 38 (e.g., such that environmental light 31 is transmitted by tint layer 42 to lens 40B, which transmits the environmental light to output coupler 38). Alternatively, tint layer 42 may be formed from lens 40B itself (e.g., tint layer 42 may impart non-zero optical power to the transmitted environmental light 31). Lens 40B and/or lens 40A may be omitted from optical system 22 if desired.

Tint layer 42 may be a fixed tint layer or may be a dynamically adjustable tint layer. When implemented as a fixed tint layer, tint layer 42 has a fixed transmission profile that absorbs the same amount of incident world light over time. Fixed tint layers may be formed from a polymer film containing dye and/or pigment (as an example). When implemented as a dynamically (electrically) adjustable tint layer, tint layer 42 has a dynamically (electrically) adjustable transmission profile. In these implementations, tint layer 42 may be controlled by control signals from control circuitry 16. Implementations in which tint layer 42 is a dynamically adjustable tint layer are described herein as an example.

Electrically adjustable tint layers (sometimes referred to as electrically adjustable light modulators or electrically adjustable light modulator layers) may be formed from an organic or inorganic electrochromic light modulator layer, a polymer-dispersed liquid crystal light modulator layer, a guest-host liquid crystal light modulator layer, and/or other types of electrically adjusted light modulator layers. When implemented using organic electrochromic tint materials, the active tint materials in the tint layer may be formed from one or more polymer layers which change their absorption upon being oxidized or reduced by charge from adjacent electrodes, or the active tint materials in the tint layer may be made from one or more species of organic small molecules, which diffuse in a liquid or gel medium and change their absorption upon being oxidized or reduced by charge from adjacent electrodes. When implemented using inorganic electrochromic tint materials, the active tint materials may be formed from one or more metal oxides, which change their absorption upon being oxidized or reduced by charge from adjacent electrodes, and may include counter-ions. Implementations in which tint layer 42 includes electrochromic tint material such as a layer of cured electrochromic gel or polymer-dispersed liquid crystal are described herein as a non-limiting example.

During operation of system 10, the electrically adjustable tint layer may be dynamically placed in a high transmission mode (sometimes referred to herein as a clear state) when it is desired to enhance the visibility of real-world objects or in a lower transmission mode (sometimes referred to herein as a dark state) when it is desired to reduce scene brightness and thereby help enhance the viewability of image light from projector 26 (e.g., to allow virtual objects such as virtual objects in image light 30 to be viewed without being overwhelmed by bright environmental light). If desired, tint layer 42 may also be controlled to exhibit intermediate levels of transmission, transmission levels that vary across the field of view of eye box 24, and/or transmission levels that transmit environmental light 31 with different color content (e.g., that change the amount of transmitted environmental light as a function of wavelength in different manners).

Tint layer 42 may be planar (e.g., having a lateral surface that lies in a flat plane) or may be curved (e.g., having a lateral surface that is curved and non-planar). Tint layer 42 may be disposed at any desired location within optical system 22 between real-world objects 28 (e.g., the scene in front of system 10) and output coupler 38 on waveguide 32. System 10 may include multiple overlapping tint layers if desired.

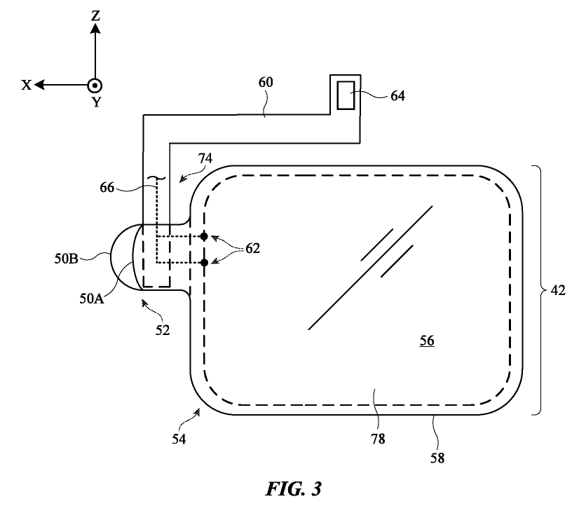

FIG. 3 is a front view of tint layer 42. In the example of FIG. 3, waveguide 32, projector 26, and lenses 40 of FIG. 2 have been omitted for the sake of clarity. As shown in FIG. 3, tint layer 42 may include one or more substrates layers 50 such as a first substrate 50A and a second substrate 50B. Substrates 50A and 50B may include glass (e.g., substrates 50A and 50B may be glass layers), polymer (e.g., plastic), or other transparent materials. Substrate layers 50 may sometimes also be referred to herein simply as substrates 50. Substrates 50A and 50B may sometimes also be referred to herein as substrate layers 50A and 50B or simply as layers 50A and 50B.

Substrate 50B may overlap substrate 50A and may be mounted to substrate 50A. When mounted together, substrates 50A and 50B may define a cavity between substrate 50A and substrate 50B. The cavity may be filled with a layer of electrochromic tint material 78 (e.g., electrochromic gel or polymer dispersed liquid crystal). Electrochromic tint material 78 may form the active area 56 of tint layer 42. Tint layer 42 may transmit light to waveguide 32 through active area 56 of tint layer 42 (e.g., while absorbing some of the light, providing the transmitted light with a desired color response, etc.).

Electrochromic tint material 78 may be cured and/or solidified during manufacture of tint layer 42. Electrochromic tint material 78 may sometimes also be referred to herein as electrochromic layer 78, electrochromic material 78, or tint material 78. A peripheral ring of adhesive such as peripheral edge seal 58 may be used to laterally contain electrochromic tint material 78 within active area 56 while helping to space substrate 50A apart from substrate 50B. Peripheral edge seal 58 may also serve to mount or adhere substrates 50A and 50B together.

As shown in FIG. 3, substrates 50A and 50B may include an extension 52 that extends or protrudes away from electrochromic tint material 78 and peripheral edge seal 58. Tint layer 42 may be driven by one or more control lines coupled to tint layer 42 at or through extension 52. For example, tint layer 42 may be driven by a printed circuit board such as flexible printed circuit 60. Flexible printed circuit 60 may include one or more control lines 66 (e.g., one or more conductive traces or other conductive lines). Control lines 66 may be coupled to control circuitry 16 (FIG. 1) over connector 64 (e.g., a board-to-board connector). Control lines 66 may extend into one or more tails 74 of flexible printed circuit 60. Tail(s) 74 of flexible printed circuit 60 may be coupled to tint layer 42 (e.g., at extension 52). Tail(s) 74 of flexible printed circuit 60 may, if desired, be adhered or mounted to substrate 50A and/or substrate 50B. Tail(s) 74 may sometimes also be referred to herein as flexible printed circuit tails.

Tint layer 42 may include first and second transparent conductive layers (not shown in FIG. 3 for the sake of clarity) extending along the lateral area of substrates 50A and 50B and the electrochromic tint material 78 in active area 56. The transparent conductive layers may form electrodes for tint layer 42. The electrodes may be formed from any desired transparent conductive material (e.g., indium tin oxide (ITO)). The electrodes may extend along opposing sides of electrochromic tint material 78. The electrodes may have terminals 62 that are coupled to control lines 66 on flexible printed circuit 60. Control lines 66 are sometimes also be referred to herein as drive lines 66. Terminals 66 are sometimes also referred to herein as drive terminals 66.

Flexible printed circuit 60 may receive control signals such as different control voltages and/or currents from driver circuitry in control circuitry 16 (FIG. 1) for driving, controlling, setting, and/or adjusting the light transmission properties of tint layer 42. Flexible printed circuit 60 may pass the control signals to the electrodes of tint layer 42 over control lines 66 and drive terminals 62. By adjusting the voltage and/or current across terminals 62, the electric field applied by the electrodes of tint layer 42 across electrochromic tint material 78 may be adjusted, thereby adjusting the amount of light transmission exhibited by electrochromic tint material 78 and thus tint layer 42.

In an illustrative configuration, electrochromic tint material 78 and tint layer 42 may exhibit a variable amount of light transmission ranging continuously between a minimum level of TMIN and a maximum level of TMAX. The value of TMIN may be 5%, 10%, 15%, 20%, 2-15%, 3-25%, 5-40%, 10-30%, 10-25%, at least 3%, at least 6%, at least 15%, at least 20%, less than 35%, less than 25%, less than 15%, or other suitable minimum level sufficient to help reduce environmental (real-world) light during viewing of computer-generated images from projectors 26 in bright environmental lighting conditions. The value of TMAX may be at least 50%, at least 60%, 60-99%, 40-99.9%, 80-99%, 70-99%, 80-97%, at least 70%, at least 80%, at least 85%, at least 90%, at least 95%, less than 99.99%, less than 99%, or other suitable maximum level sufficiently transparent to allow a viewer to comfortably view real world objects through tint layer 42 during situations where projectors 26 (FIG. 2) are not supplying images or other situations where higher transmission levels are desirable. If desired, the control signals may also be adjusted to adjust a color response (e.g., transmission as a function of wavelength) of electrochromic tint material 78.

If desired, anti-reflective coatings (not shown), index matching layers (not shown), additional adhesive layers (not shown), and/or any other additional layers may be disposed on one or both of substrates 50A and 50B. In implementations where tint layer 42 is curved, substrates 50A and 50B may be curved. The example of FIG. 3 in which tint layer 42 includes two substrates 50 is illustrative and non-limiting. If desired, tint layer 42 may include only a single substrate 50 or more than two substrates 50. Tint layer 42 may be implemented using other structures if desired.

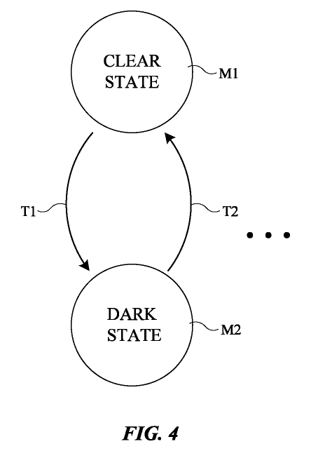

Tint layer 42 may be switched between at least two steady states. FIG. 4 is a state diagram illustrating how tint layer 42 may be switched between at least two steady states (modes). As shown in FIG. 4, tint layer 42 may be operable in a first steady state M1 and in a second steady state M2. Steady state M1 may be a clear state of tint layer 42 and is therefore sometimes referred to herein as clear state M1 or clear steady state M1. Tint layer 42 may exhibit a maximum transmission level TMAX in clear state M1. Steady state M2 may be a dark state of tint layer 42 and is therefore sometimes referred to herein as dark state M2 or dark steady state M2. Tint layer 42 may exhibit a minimum transmission level TMIN in dark state M2.

Tint layer 42 may be driven by electric drive signals (e.g., voltage or current signals). A driver for tint layer 42 (not shown in FIG. 3 for the sake of clarity) may generate the drive signals and may supply the drive signals to tint layer 42 over control lines 66 of FIG. 3. The driver may adjust the drive signal (e.g., by adjusting the peak voltage or current magnitude of the drive signals) to transition the tint layer between clear state M1 and dark state M2. For example, the driver may perform a first adjustment to transition the tint layer from clear state M1 to dark state M2, as shown by arrow T1. Tint layer 42 may be in a transient (non-steady) state during the transition associated with arrow T1. In the transient state, the transmission level of the tint layer is actively changing from the transmission level associated with clear state M1 to the transmission level associated with dark state M2. Once the transmission level has stabilized, tint layer 42 enters dark state M2 in a steady state condition. On the other hand, the driver may perform a second adjustment to transition the tint layer from dark state M2 to clear state M1, as shown by arrow T2. Tint layer 42 may be in a transient state during the transition associated with arrow T2. In the transient state, the transmission level of the tint layer is actively changing from the transmission level associated with dark state M2 to the transmission level associated with dark state M1. Once the transmission level has stabilized, tint layer 42 enters clear state M1 in a steady state condition.

The driver may continue to drive the tint layer using the drive signal while in a steady state (e.g., while tint layer 42 is in clear state M1 or dark state M2). The drive signal may be a periodic signal that contains a periodic sequence of signal pulses (e.g., a square voltage signal). The periodic signal may have a substantially constant peak magnitude voltage or current while driving the tint layer in a steady state. This may ensure that the tint layer continues to exhibit a substantially constant transmission level over time while in the steady state (e.g., a transmission level that varies by less than a threshold percentage). While in a steady state, the transmission level of tint layer 42 may vary by less than a threshold percentage of around 1-15%, for example. Small variations in the transmission level of tint layer 42 while in a steady state may, for example, be the result of the drive signal switching polarity. The example of FIG. 4 is illustrative and non-limiting and, if desired, tint layer 42 may have additional states (e.g., states associated with a gradient transmission level across the area of the tint layer, states associated with different transmitted color profiles, one or more intermediate darkness states with transmission levels between the transmission level of the clear state and the transmission level of the dark state, etc.). Display 20 is sometimes referred to herein as being or operating in clear state M1 while tint layer 42 is in clear state M1 and is sometimes referred to herein as being or operating in dark state M2 while tint layer 42 is in dark state M2.

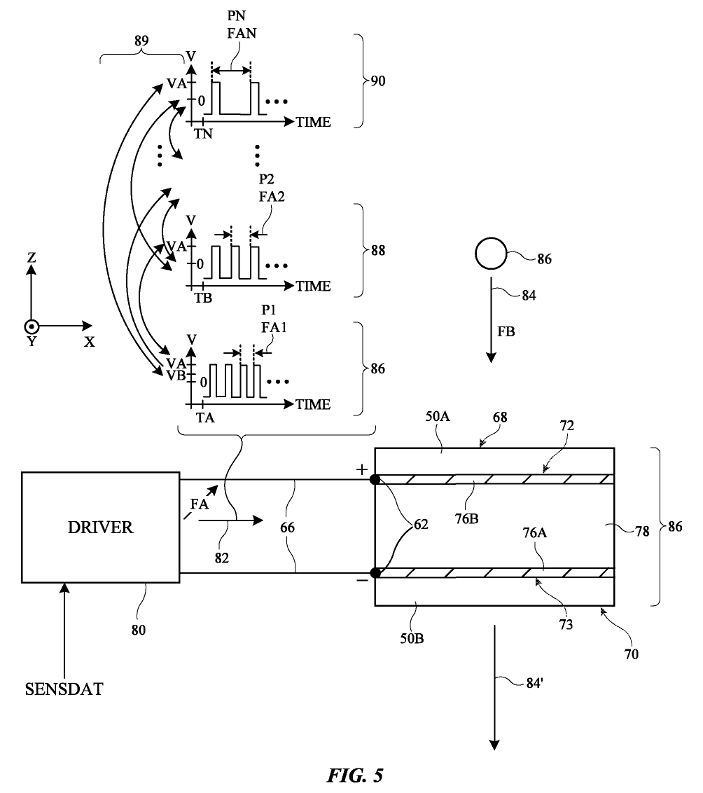

FIG. 5 is a diagram showing how tint layer 42 may be driven by a drive voltage provided over control lines 66 of FIG. 3. As shown in FIG. 5, tint layer 42 may be driven by driver circuitry such as driver 80. Driver 80 may be coupled to tint layer 42 over control lines 66. Driver 80 may be mounted to a substrate of tint layer 42, may be mounted to flexible printed circuit 60 (FIG. 2), may be mounted to the main logic board or another logic board in system 10 (e.g., may be coupled to flexible printed circuit 60 over connector 64), may be implemented on an application specific integrated circuit (ASIC) that is specifically designed to drive tint layer 42, may be implemented on another control chip in system 10 that performs additional functions, etc.

FIG. 5 also shows a cross-sectional top view of tint layer 42. As shown in the cross-sectional top view of FIG. 5, substrates 50A and 50B may extend along opposing sides of electrochromic tint material 78 (e.g., electrochromic tint material 78 may be sandwiched or interposed between substrates 50A and 50B). This example is illustrative and, if desired, electrochromic tint material 78 may be replaced with other materials that exhibit different optical transmission characteristics when driven using electrical signals having different properties (e.g., liquid crystal based materials, etc.). Substrate 50A may have a first lateral surface 68 and an opposing second lateral surface 72. Substrate 50B may have a first lateral surface 73 and an opposing second lateral surface 70. Lateral surface 70 or lateral surface 68 may be mounted to a lateral surface of waveguide 32 (FIG. 2) using optically clear adhesive, epoxy, spacers, or other mounting structures. If desired, an air gap may be present between lateral surface 70 and waveguide 32. Lateral surfaces 72 and 73 may face electrochromic tint material 78.

Tint layer 42 may include a first electrode layer such as electrode 76B that is layered onto lateral surface 72 and that is interposed between substrate 50A and electrochromic tint material 78. Tint layer 42 may also include a second electrode layer such as electrode 76A that is layered onto lateral surface 73 and that is interposed between substrate 50B and electrochromic tint material 78. Control lines 66 may be coupled to electrodes 76A and 76B at drive terminals 62 (e.g., driver 80 may be coupled to electrodes 76A and 76B over control lines 66 and drive terminals 62).

As shown in the example of FIG. 5, driver 80 may drive electrodes 76A and 76B using a drive signal 82 supplied to electrodes 76A and 76B through control lines 66 (e.g., a drive voltage applied across electrodes 76A and 76B or a drive current). Drive signal 82 may include a periodic series of pulses (e.g., voltage or current pulses/peaks) at a corresponding drive frequency FA (e.g., as a bipolar square wave). One or more characteristics of drive signal 82 such as the pulse magnitude and/or timing of drive signal 82 may configure electrochromic tint material 78 to exhibit a desired level of optical transmission and/or a desired color response (e.g., to place tint layer 42 into a selected one of clear state M1 or dark state M2 of FIG. 4). The one or more characteristics may be adjusted over time to change the level of optical transmission of electrochromic tint material 78 and thus tint layer 42 (e.g., to transition the tint layer between clear state M1 and dark state M2). Tint layer 42 may be in a steady state (e.g., one of clear state M1 or dark state M2) while the one or more characteristics are held substantially constant over time.

In some situations, there may be one or more artificial light sources such as light source 86 in the environment around and/or in front of system 10. Light source 86 may emit artificial light 84. Artificial light 84 may, for example, form some or all of environmental light 31 of FIG. 2. Artificial light 84 is sometimes also referred to herein as world light 84, ambient light 84, scene light 84, or environmental light 84. Tint layer 42 may transmit incident artificial light 84 towards waveguide 32 (FIG. 2) and the eye box as transmitted light 84’. Transmitted light 84’ may also include natural light from the environmental light 31 (FIG. 2) incident upon tint layer 42. While tint layer 42 is in dark state M2, transmitted light 84’ may be provided to the eye box at a minimum intensity (e.g., given by the minimum transmission level TMIN of tint layer 42). While tint layer 42 is in clear state M1, transmitted light 84’ may be provided to the eye box at a maximum intensity (e.g., given by the maximum transmission level TMAX of tint layer 42).

Artificial light source 86 may emit artificial light 84 with an intensity that periodically and rapidly varies as a function of time at a fixed frequency FB. This may occur, for example, when artificial light source 86 is or includes an alternating current (AC) driven light source such as a light-emitting diode (LED) (e.g., when artificial light source 86 is an LED-based light source such as an LED light bulb, an LED projector, an LED display, an OLED display, a uLED display, or a display of an external device such as a mobile phone, tablet computer, computer monitor, television, etc., that emits artificial light 84 according to a corresponding emissions cycle at frequency FB). Artificial light 84 may be incident upon tint layer 42 when the user of system 10 is wearing system 10 and viewing artificial light source 86 (e.g., a screen or display of another device) through waveguide 32, output coupler 38 (FIG. 2), and tint layer 42. Frequency FB of the intensity modulations in artificial light 84 may be, for example, 60 Hz, 120 Hz, 65 Hz, 10-120 Hz, 40-480 Hz, 90-96 Hz, 50-60 Hz, 37.5-125 Hz, 75-125 Hz, or other frequencies.

For certain frequencies FB, if care is not taken, the drive frequency FA of the drive signal 82 used to drive tint layer 42 while the tint layer is in a steady state may cause tint layer 42 to produce unsightly cosmetic artifacts in transmitted light 84’. These cosmetic artifacts may include, for example, at least (1) subharmonic flicker artifacts associated with beating between frequency FA and frequency FB (sometimes also referred to herein as subharmonic flickering) and/or (2) intrinsic flicker artifacts from tint layer 42 on its own. The subharmonic flicker artifacts (1) may be associated with short persistence light conditions and may occur, for example, when |FA – k*FB| ~ 10 Hz, where k is an integer greater than or equal to one. The value |FA – k*FB| may, for example, represent a beating frequency between frequencies FA and FB. This beating may become particularly pronounced, for example, when the frequency difference between drive signal 82 and artificial light 84 (e.g., the value |FA – k*FB|) is relatively small (e.g., 10-20 Hz or lower). Put differently, drive signal 82 may have a sufficiently high frequency FA such that natural environmental light transmitted by tint layer 42 in a steady state does not contain noticeable flickering or beating when viewed at the eye box, and frequency FB may be sufficiently high such that artificial light source 86 does not appear to flicker when directly viewed by the human eye, but situations may arise when frequencies FA and FB are sufficiently close such that artificial light 84 appears with noticeable or distracting flickering/beating when viewed at the eye box (e.g., in transmitted light 84’). The flicker artifacts (2) from tint layer 42 itself may be associated with long persistence light conditions and may occur when frequency FA is relatively low (e.g., around 10 Hz).

To help mitigate and prevent these flicker artifacts in transmitted light 84’, driver 80 may output drive signal 82 as a spread spectrum drive signal. This may involve driver 80 outputting drive signal 82 with a frequency FA that varies over time while tint layer 42 is in a steady state (e.g., the frequency FA of drive signal 82 may be spread across a range of frequencies over time). Driver 80 may vary frequency FA in a manner that reduces, prevents, mitigates, and/or minimizes the production of flickering artifacts in transmitted light 84’. This may include, for example, adjusting the frequency FA of drive signal 82 between a set of N different frequencies FA over time while tint layer 42 is in a steady state. The variation may be random (e.g., pseudorandom) or may follow a predetermined frequency hopping schedule. N may be any desired integer (e.g., two, three, four, five, more than five, more than ten, more than 100, more than 1000, etc.). If desired, driver 80 may adjust frequency FA between frequencies in a continuous range of frequencies (e.g., N may approach infinity). The variation in frequency FA over time may serve to minimize the likelihood that frequency FA will be sufficiently close to frequency FB for a sufficiently long period of time so as to produce noticeable flickering artifacts in transmitted light 84’.

Portions 86-88 of FIG. 5 illustrate how driver 80 may adjust the frequency FA of drive signal 82 over time to mitigate flickering artifacts in transmitted light 84’. Portions 86-88 of FIG. 5 illustrate three examples of voltage waveforms for drive signal 82 (e.g., measured between terminals 62 of tint layer 42 as a function of time, in volts V) at three different frequencies FA that may be produced by driver 80 during different time periods while tint layer 42 remains in the same steady state (e.g., a first steady state). This is illustrative and, in other implementations, drive signal 82 may include a current waveform.

As shown in portion 86 of FIG. 5, driver 80 may output drive signal 82 as a series of periodic pulses of magnitude (amplitude) VA during a first time period beginning at time TA (e.g., drive signal 82 may be a bipolar square wave having positive pulses of magnitude VA and negative pulses of magnitude VA and that switches polarity between the positive and negative pulses). Driving tint layer 42 using a bipolar square wave such as drive signal 82 may serve to stabilize tint layer 42 in the corresponding steady state (e.g., without the degradation to the electrochromic material in tint layer 42 that is otherwise associated with driving the tint layer using a direct current (DC) drive voltage). The pulses of drive signal 82 have period P1. Period P1 is relatively short, causing drive signal 82 to exhibit a relatively high frequency FA1 (e.g., where P1 = 1/FA1). The pulses of drive signal 82 may have a substantially constant magnitude VA for the duration of the first time period (e.g., because tint layer 42 is in a steady state).

As shown in portion 88 of FIG. 5, driver 80 may output drive signal 82 as a series of periodic pulses of magnitude VA during a second time period beginning at time TB. The second time period is different than the first time period. These pulses have period P2. Period P2 is longer than period P1, causing drive signal 82 to exhibit a frequency FA2 that is lower than frequency FA1 (e.g., where P2 = 1/FA2). The pulses of drive signal 82 may have a substantially constant magnitude VA for the duration of the second time period (e.g., because tint layer 42 is in a steady state). Tint layer 42 remains in the first steady state (e.g., does not enter into a transient state and does not switch to a different steady state) during the first time period, during the second time period, and between the first and second time periods.

As shown in portion 90 of FIG. 5, driver 80 may output drive signal 82 as a series of periodic pulses of magnitude VA during an Nth time period beginning at time TN. The Nth time period is different than the first time period and the second time period. These pulses have period PN. Period PN is longer than period P2, causing drive signal 82 to exhibit a frequency FAN that is lower than frequency FA2 (e.g., where PN = 1/FAN). The pulses of drive signal 82 may have a substantially constant magnitude VA for the duration of the Nth time period (e.g., because tint layer 42 is in a steady state). Tint layer 42 remains in the first steady state (e.g., does not enter into a transient state and does not switch to a different steady state) during the first time period, during the second time period, during the Nth time period, between the first and Nth time periods, and between the second and Nth time periods.

In this example, N is greater than or equal to three. This may be generalized to any desired integer N or to a continuous variation in frequency FA when N approaches infinity. As shown by arrows 89, driver 80 may adjust drive signal 82 between the set of N different frequencies FA over time while tint layer 42 remains in the first steady state. This switch between frequencies FA may follow a frequency hopping schedule that dictates frequency FA over time. The frequency hopping schedule may include random (e.g., pseudorandom) frequency hops or may include predetermined frequency hops (e.g., may be a random frequency hopping schedule or a predetermined frequency hopping schedule).

Driver 80 may adjust one or more characteristics of drive signal 82 (e.g., the voltage magnitude of the pulses in drive signal 82, etc.) to switch tint layer 42 from the first steady state to a second steady state. For example, driver 80 may reduce the pulse magnitude of drive signal 82 to switch from the first steady state to the second steady state. In the second steady state, driver 80 may output drive signal 82 with pulses at a magnitude VB that is different than magnitude VA. Driver 80 may output drive signal 82 with pulses at a substantially constant magnitude VB while tint layer 42 remains in the second steady state. If desired, driver 80 may perform similar adjustments to the frequency FA of drive signal 82 while in the second steady state to prevent the production of flicker artifacts in transmitted light 84’. In some implementations, the magnitude VB of the second steady state may be equal to zero (e.g., drive signal 82 may include no signal pulses while tint layer 42 is in the second steady state). In these examples, the first steady state (e.g., with drive signal pulses at magnitude VA) may be clear state M1 whereas the second steady state (e.g., drive signal at a constant V = 0 volts) may be dark state M2. Magnitude VA may be, for example, 60-70 V or another voltage between around 0 V and around 60-70V.

If desired, driver 80 may set and/or adjust/update the frequency FA of drive signal 82 over time based on sensor data SENSDAT. Sensor data SENSDAT may be generated by one or more sensors in components 18 of FIG. 1. The one or more sensors may generate sensor data SENSDAT based on artificial light 84 and/or artificial light source 86. Sensor data SENSDAT may, for example, include light sensor data, camera data, image sensor data, and/or other data sensed (measured) from artificial light 84 and/or otherwise indicative of artificial light 84 and/or frequency FB. Sensor data SENSDAT may, for example, include or identify frequency FB of artificial light 84. Driver 80 may, for example, begin varying the frequency FA of drive signal 82 (e.g., using one or more of the methods described herein) if/when sensor data SENSDAT indicates that artificial light 84 at frequency FB is incident upon tint layer 42 (e.g., in response to system 10 entering an environment containing artificial light sources 86 and/or artificial light 84). Additionally, or alternatively, driver 80 may adjust frequency FA (e.g., may generate and implement a frequency hopping schedule for drive signal 82, may select frequencies FA, may select integer N, etc.) based on the frequency FB of artificial light 84 as included in or identified by sensor data SENSDAT (e.g., to dynamically adjust the frequency of drive signal 82 to mitigate beating with the current measured frequency FB of artificial light 84). This is illustrative and, if desired, driver 80 may generate and adjust drive signal 82 independent of sensor data SENSDAT (e.g., driver 80 need not receive sensor data SENSDAT).

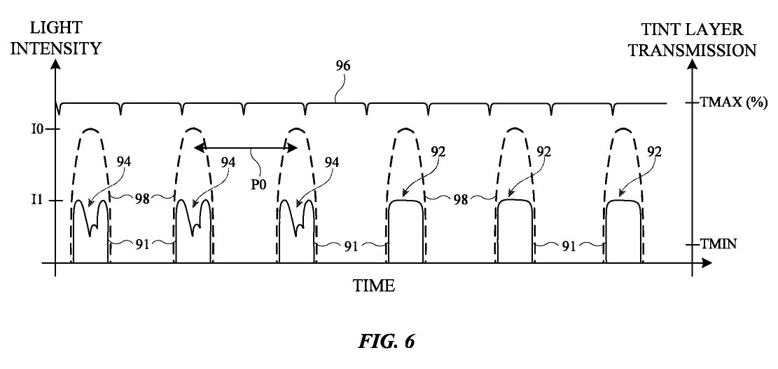

FIG. 6 is a timing diagram showing one example of how varying the frequency FA of drive signal 82 while tint layer 42 is in a steady state may serve to mitigate flicker artifacts in transmitted light 84’. Curve 96 of FIG. 6 plots the transmission level (in percent) of tint layer 42 (e.g., the ratio of intensity of transmitted light 84’ (FIG. 5) to the intensity of the world light 31 (FIG. 2) incident upon tint layer 42) over time. FIG. 6 illustrates an example in which tint layer 42 is in clear state M1. As shown by curve 96, in clear state M1, tint layer 42 may exhibit a substantially constant and relatively high transmission level such as maximum transmission level TMAX over time. Curve 96 may include small periodic dips (e.g., by less than 10-15%) each time the polarity of drive signal 82 changes but that do not otherwise substantially change the transmission level of tint layer 42 below maximum transmission level TMAX while tint layer 42 is in the steady state.

Dashed curves 98 illustrate the intensity of environmental light 31 incident upon tint layer 42. As shown by curves 98, environmental light 31 may include artificial light 84 that is incident upon tint layer 42 as a periodic series of intensity pulses at magnitude I0. Artificial light source 86 (FIG. 5) may emit the artificial light with periodic intensity pulses at frequency FB, which corresponds to a period P0 (e.g., where P0 = 1/FB). Curves 91 illustrate the intensity of the transmitted light 84’ output by tint layer 42 from the incident environmental light. As shown by curves 91, transmitted light 84’ may have an intensity I1 that is less than intensity I0 (e.g., tint layer 42 may still reduce the intensity of incident light by I0 - I1 when in the clear state). Intensity I1 is still substantially greater than the minimum transmission level TMIN of tint layer 42 when operated in dark state M2.

If/when the frequency FA of drive signal 82 is sufficiently close to the frequency FB of the intensity modulations in artificial light 84, beating between frequency FA and frequency FB may produce subharmonic flickering artifacts in the transmitted light 84’. These flickering artifacts are represented by distortions 94 (e.g., deteriorations, distortions, dips, reductions, troughs, perturbations, and/or other distortions) in one or more of the intensity peaks of transmitted light 84’ (curves 91), causing various reductions in the intensity of curves 91 below intensity I1 over time. By varying the frequency FA of drive signal 82 over time, driver 80 may cause tint layer 42 to output transmitted light 84’ having uniform intensity peaks over time (e.g., as shown by uniform intensity peaks 92 of curves 91 at intensity I1). The uniform intensity peaks do not include sub-harmonic flickering artifacts. In this way, driver 80 may mitigate the production of sub-harmonic flickering artifacts in transmitted light 84’ that would otherwise be noticeable and/or distracting to a viewer at the eye box.

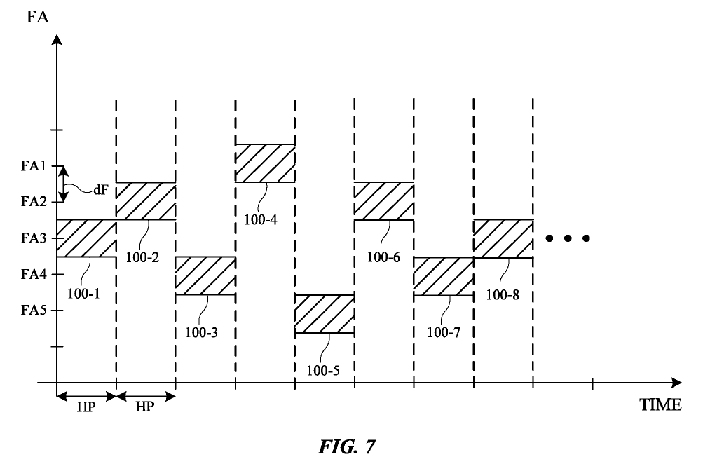

FIG. 7 is a timing diagram showing one example of how driver 80 may vary the frequency FA of drive signal 82 over time to mitigate flickering in transmitted light 84’. In the example of FIG. 7, driver 80 varies drive signal 82 between a set of N = 5 different frequencies FA such as frequencies FA1, FA2, FA3, FA4, and FA5. Blocks 100 of FIG. 7 represent the frequency of drive signal 82 at corresponding times as plotted on the horizontal axis. In practice, driver 80 may transmit drive signal 82 within N small ranges (channels) of frequencies, each centered around a corresponding frequency FA (e.g., frequencies FA may represent center frequencies of each range of frequencies). Each block 100 may represent the small range of frequencies of drive signal 82, centered about a corresponding center frequency FA (e.g., blocks 100 may have a finite height measured along the vertical axis). Alternatively, drive signal 82 may be output at single precise frequencies FA (e.g., blocks 100 may have infinitesimal height measured along the vertical axis).

Driver 80 may output drive signal 82 at each frequency FA for a corresponding frequency hopping period HP. Frequency hopping period may correspond to a hopping frequency FH (e.g., where FH = 1/HP). Hopping frequency FH represents the frequency with which driver 80 changes the frequency FA of drive signal 82 over time while tint layer 42 remains in a corresponding steady state.

In the example of FIG. 7, the N = 5 frequencies FA of drive signal 82 are uniformly separated in frequency space by frequency gap dF (e.g., frequency FA2 is lower than frequency FA1 by frequency gap dF, frequency FA3 is lower than frequency FA2 by frequency gap dF, frequency FA4 is lower than frequency FA3 by frequency gap dF, and frequency FA5 is lower than frequency FA4 by frequency gap dF). Frequency gap dF is sometimes also referred to herein as frequency spacing dF. In addition, each hopping period HP has the same duration in the example of FIG. 7. This is illustrative and non-limiting. If desired, the N frequencies FA of drive signal 82 may be non-uniformly separated in frequency space. If desired, the duration of hopping periods HP may vary over time (e.g., driver 80 may vary hopping frequency FH over time).

The example of FIG. 7 illustrates one possible frequency hopping schedule that may be implemented by driver 80 when transmitting drive signal 82. The frequency hopping schedule may specify the particular frequency FA of drive signal 82 during different hopping periods HP over time. The frequency hopping schedule may be predetermined (e.g., stored in storage circuitry on system 10) and/or may be selected as the particular frequency hopping schedule that minimizes the amount of flickering artifacts in transmitted light 84’ for the current frequency FB of artificial light 84 (e.g., as detected using sensor data and identified in sensor data SENSDAT of FIG. 5). Alternatively, the frequency hopping schedule may represent the random selection or distribution of different frequencies FA for drive signal 82 over time by driver 80. As used herein, a “random” selection means either a purely (mathematically) random selection or a pseudorandom selection (e.g., as generated using a pseudorandom number generation algorithm or procedure).

As shown in the example of FIG. 7, for instance, driver 80 may output drive signal 82 at frequency FA3 during a first hopping period HP (as shown by block 100-1). As shown by block 100-2, driver 80 may then output drive signal 82 at frequency FA2 during a second hopping period HP. As shown by block 100-3, driver 80 may then output drive signal 82 at frequency FA4 during a third hopping period HP. As shown by block 100-4, driver 80 may then output drive signal 82 at frequency FA1 during a fourth hopping period HP. As shown by block 100-5, driver 80 may then output drive signal 82 at frequency FA5 during a fifth hopping period HP. As shown by block 100-6, driver 80 may then output drive signal 82 at frequency FA2 during a sixth hopping period HP. As shown by block 100-7, driver 80 may then output drive signal 82 at frequency FA4 during a seventh hopping period HP. As shown by block 100-8, driver 80 may then output drive signal 82 at frequency FA3 during an eighth third hopping period HP.

This may, for example, represent a repeating (e.g., predetermined and non-random) frequency hopping pattern in which drive signal 82 is supplied to tint layer 82 at each one of the N = 5 different frequencies FA at least twice during eight consecutive hopping periods HP (e.g., driver 80 spreads the spectrum of driving signal 82 across N = 5 different frequencies FA over eight consecutive hopping periods HP while tint layer 42 remains in a steady state). Driver 80 may implement this type of frequency hopping schedule if/when the frequency hopping schedule serves to minimize the production of flicker artifacts in transmitted light 84’. Alternatively, driver 80 may implement a random frequency hopping schedule in which drive signal randomly varies between the N frequencies FA across any desired number of consecutive hopping periods while tint layer 42 remains in the steady state. If desired, driver 80 may uniformly weight each of the N frequencies FA in the hopping schedule (e.g., the random distribution of frequencies FA over time) such that each of the N frequencies FA is used a uniform number of times over time. Alternatively, driver 80 may weight some of the N frequencies FA more than others in the hopping schedule (e.g., the random distribution of frequencies FA over time) such that some of the N frequencies FA are used more often than others of the N frequencies FA over time.

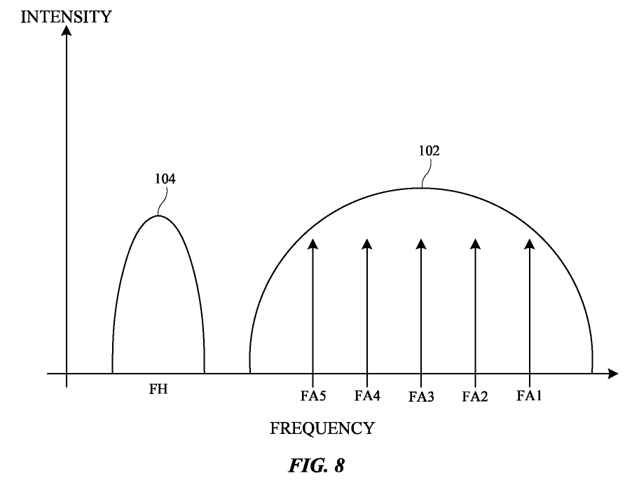

FIG. 8 is a simplified plot of drive signal 82 in the frequency domain. The plot of FIG. 8 may, for example, be generated by performing a Fourier transform on drive signal 82 in the time domain (as illustrated in FIG. 7). As shown by curve 102 of FIG. 8, rather than including a single peak at a single frequency FA, drive signal 82 is spectrum spread across a range of frequencies that includes frequencies FA1 through FA5. Drive signal 82 may also exhibit an additional peak at lower frequencies, shown by curve 104, associated with (overlapping) the hopping frequency FH with which driver 80 changes frequency FA of drive signal 82 (e.g., drive signal 82 may have an envelope at hopping frequency FH). This spectrum spreading may serve to reduce or eliminate the production of flicker artifacts (see, e.g., distortions 94 of FIG. 6) in transmitted light 84’.

In practice, hopping frequency FH (or equivalently the duration of hopping periods HP), integer N, and/or the size of frequency gap dF represent tuning knobs that may be adjusted by driver 80 while generating drive signal 82 to adjust how driver 80 mitigates flicker artifacts in transmitted light 84’ (e.g., to remove subharmonic flicker artifacts (1) associated with beating between frequencies FA and FB without tint layer 42 itself generating flicker artifacts (2)). If desired, driver 80 may sweep over one or more of these parameters until an optimal set of parameters is found that minimizes flicker artifacts in transmitted light 84’ (e.g., for the corresponding frequency FB of artificial light 84). As one example, wider frequency distributions of drive signal 82 (e.g., greater integers N) may serve to lower the peak of beating between the frequencies FA and FB (reducing subharmonic flicker artifacts (1)) but can sometimes also increase flicker artifacts (2) produced by tint layer 42 itself. As another example, decreasing frequency gap dF may decrease subharmonic flicker artifacts (1) as well as flicker artifacts (2) produced by tint layer 42 itself. As another example, increasing hopping frequency FH may decrease flicker artifacts (2) produced by tint layer 42 itself.

If desired, driver 80 may sweep over one or more of these parameters while tint layer 42 is in a steady state to identify an optimal set of parameters for mitigating subharmonic flicker artifacts (1) and/or minimizing flicker artifacts (2) produced by tint layer 42 itself for the current environmental conditions for system 10 (e.g., frequency FB). This sweep may occur in the field and one or more sensors may measure transmitted light 84’ until a set of parameters that minimizes flicker artifacts detected by the sensor(s) is found, and driver 80 may then drive tint layer 42 using drive signals 82 that are frequency-varied with that set of parameters. Alternatively, this sweep may occur during design, manufacture, assembly, and/or calibration of system 10 (e.g., in factory or in a calibration system) prior to use of system 10 by an end user. As one example, when frequency FB is 60 Hz (e.g., when artificial light source 86 is a 60 Hz display), driver 80 may generate drive signal 80 with an optimal set of parameters that includes a frequency gap dF of around 1 Hz (e.g., 0.5-1.5 Hz, 0.5-2 Hz, etc.) and with N = 60, 50-70, or 40-80 (e.g., with N = 60 frequency channels with N = 60 different center frequencies FA dispersed across a 60 Hz window). As another example, driver 80 may generate drive signal 80 with an optimal set of parameters that includes a frequency gap dF much greater than 1 Hz (e.g., 5-15 Hz, 10 Hz, 5-50 Hz, greater than 5 Hz, greater than or equal to 10 Hz, 20 Hz, 10-20 Hz, 5-30 Hz, etc.) and with N = 7, 5-10, 5-15, or 6-8. These examples are illustrative and non-limiting.

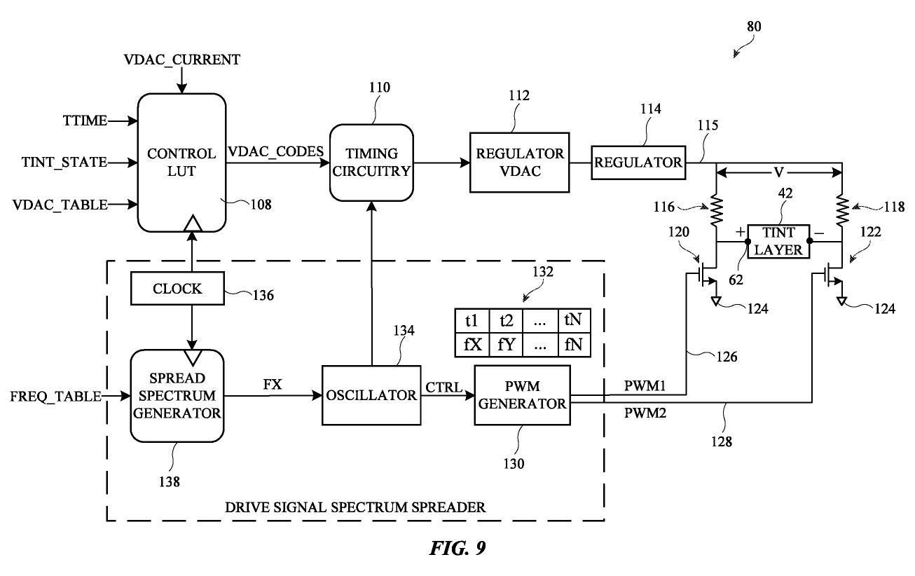

FIG. 9 is a circuit diagram showing one example of circuitry that may be included in driver 80 for generating drive signal 82. As shown in FIG. 9, the terminals of tint layer 62 may be coupled to a first source-drain terminal (e.g., drain terminals) of transistors 120 and 122. Transistors 120 and 122 may have second source-drain terminals (e.g., source terminals) coupled to reference potential 124 (e.g., a ground voltage or another reference voltage). The terms “source” and “drain” are sometimes used interchangeably when referring to current-conducting terminals of a metal-oxide-semiconductor (MOS) transistor. The source and drain terminals are therefore sometimes referred to as “source-drain” terminals (e.g., a transistor has a gate terminal, a first source-drain terminal, and a second source-drain terminal).

Transistor 120 may have a gate terminal coupled to a first control line 126 (e.g., a first pulse width modulation (PWM) control line). Transistor 122 may have a gate terminal coupled to a second control line 128 (e.g., a second PWM control line). Driver 80 may include voltage generation circuitry such as regulator 114 (e.g., a low drop out (LDO) regulator, buck converter, etc.). The output of regulator 114 may be coupled to terminals 62 of tint layer 42 and the first source-drain terminals of transistors 120 and 122 over control line 115. For example, a first node on control line 115 may be coupled to the first source-drain terminal of transistor 120 and a first terminal 62 of tint layer 42 by a first resistor 116. A second node on control line 115 may be coupled to the first source-drain terminal of transistor 122 and a second terminal 62 of tint layer 42 by a second resistor 118. Control lines 115, 126, and 128, transistors 120 and 122, and resistors 116 and 118 may collectively form control lines 66 of FIGS. 3 and 5.

Regulator 114 may produce a voltage V between the terminals 62 of tint layer 115. Control line 126 may carry a first PWM control signal PWM1 to the gate terminal of transistor 120 that toggles transistor 120 between active and inactive states. Control line 128 may carry a second PWM control signal PWM2 to the gate terminal of transistor 122 that toggles transistor 122 between on and off states. When transistor 120 is in an active state, current flows through resistor 116, through the source-drain terminals of transistor 120, and between control line 115 and reference potential 124. When transistor 120 is in an inactive state, current flow from control line 115 to reference potential 124 through resistor 116 and transistor 120 stops. When transistor 122 is in an active state, current flows through resistor 118, through the source-drain terminals of transistor 122m and between control line 115 and reference potential 124. When transistor 122 is in an inactive state, current flow from control line 115 to reference potential 124 through resistor 118 and transistor 122 stops.

Transistors 120 and 122 may be toggled between inactive and active states over time (e.g., by PWM signals PWM1 and PWM2 respectively), producing periodic signal pulses in voltage V and causing voltage V to be applied across tint layer 42 as a binary square wave (e.g., forming the drive signal 82 used to drive tint layer 42 as shown by portions 86-90 of FIG. 5). The timing with which transistors 120 and 122 are toggled (e.g., the timing of PWM signals PWM1 and PWM2) may serve to set the frequency FA of drive signal 82. By adjusting this timing, driver 80 may adjust the frequency FA of drive signal 82 (e.g., in a manner that mitigates flicker artifacts in transmitted light 84’ while tint layer 42 is in a steady state). Regulator 114 may set the magnitude of the pulses of drive signal 82 (e.g., to place and hold tint layer 42 in a corresponding steady state). This example is illustrative and non-limiting. Other driving schemes may be used to drive tint layer 42 using drive signal 82.

The term “activate” with respect to a switch (or transistor) may refer to or be defined herein as an action that places the switch in an “on”or low-impedance state such that the two terminals of the switch are electrically connected to conduct current. Activating a switch can sometimes be referred to as turning on or closing a switch. The term “deactivate” with respect to a switch (or transistor) may refer to or be defined herein as an action that places the switch in an “off” or high-impedance state such that the two terminals of the switch/transistor are electrically disconnected with minimal leakage current. Deactivating a switch can sometimes be referred to as turning off or opening a switch.

As shown in FIG. 9, driver 80 may also include a control lookup table (LUT) 108, timing circuitry 110, a regulator voltage digital-to-analog converter (VDAC), and drive frequency spectrum spreading circuitry such as drive signal spectrum spreader 106. Drive signal spectrum spreader 106 may include clocking circuitry such as clock 136 (e.g., a microcontroller (MCU) clock). Clock 136 may supply a clocking signal to a clock input of control LUT 108. The output of control LUT 108 may be operably coupled to an input of timing circuitry 110. The output of timing circuitry 110 may be coupled to the input of regulator VDAC 112.

Drive signal spectrum spreader 106 may include oscillator circuitry such as oscillator 134 (e.g., a master oscillator). Oscillator circuitry 134 may provide an oscillating signal to a timing input of timing circuitry 110. Drive signal spectrum spreader 106 may also include spread spectrum generation circuitry such as spread spectrum generator 138 and may include PWM control signal generator circuitry such as PWM generator 130. Control LUT 108, timing circuitry 110, clock 136, and/or part of spread spectrum generator 138 may include digital circuitry, for example. PWM generator, oscillator 134, and/or regulator 114 may include analog circuitry, for example.

Control LUT 108 may have a first control input that receives a first control signal VDAC_CURRENT that includes or identifies a current setting and/or output of regulator VDAC 112 (e.g., a current digital code used by regulator VDAC 112). Control LUT 108 may have a second control input that receives a second control signal TTIME that includes or identifies a transition time for tint layer 42. Control LUT 108 may have a third control input that receives a third control signal TINT_STATE that includes or identifies the current steady state of tint layer 42 (e.g., clear state M1 or dark state M2). Control LUT 108 may have a fourth input that receives a fourth control signal VDAC_TABLE that includes or identifies a table of VDAC settings (e.g., digital control codes) for regulator VDAC 112.

During operation, control LUT 108 may output, based on one or more of control signals VDAC_CURRENT, TTIME, TINT_STATE, and VDAC_TABLE, a digital control signal VDAC_CODES that includes or identifies a list of VDAC codes for regulator VDAC 112. Timing circuitry 110 may update and/or synchronize timing of digital control signal VDAC_CODES with the timing of drive signal spectrum spreader 106 (e.g., to synchronize PWM performed by drive signal spectrum spreader 106 with the voltage level output by regulator 114). Regulator VDAC 112 may generate an analog control signal based on digital control signal VDAC_CODES that controls regulator 114 to produce voltage V across tint layer 42.

At the same time, clock 136 may provide a clocking signal to a clock input of spread spectrum generator 138. Spread spectrum generator 138 may also receive a control signal FREQ_TABLE that includes or identifies a table of different frequencies FA for drive signal 82. Spread spectrum generator may generate an analog control signal FX that includes or identifies a set of N of the frequencies identified by control signal FREQ_TABLE. The output of PWM generator 130 may be coupled to PWM control lines 126 and 128. Oscillator 134 may generate a control signal CTRL (e.g., a control clock) that drives PWM generator 130 to generate PWM signals PWM1 and PWM2 in a manner that causes drive signal 82 to be driven across tint layer 42 with a different one of the N frequencies identified by analog control signal FX during respective hopping periods HP over time. Table 132 illustrates, for example, how PWM generator 130 may map the output by oscillator 134 (control signal CTRL) to N different frequencies f (e.g., frequencies FA) during different time periods t, supplying PWM signals PWM1 and PWM2 that drive transistors 120 and 122 to cause drive signal 82 to exhibit different frequencies FA during the different time periods t, implementing a corresponding frequency hopping schedule for drive signal 82. The example of FIG. 9 is illustrative and non-limiting and, if desired, drive circuitry 80 may include other circuitry for driving tint layer 42 according to the frequency hopping schedule.

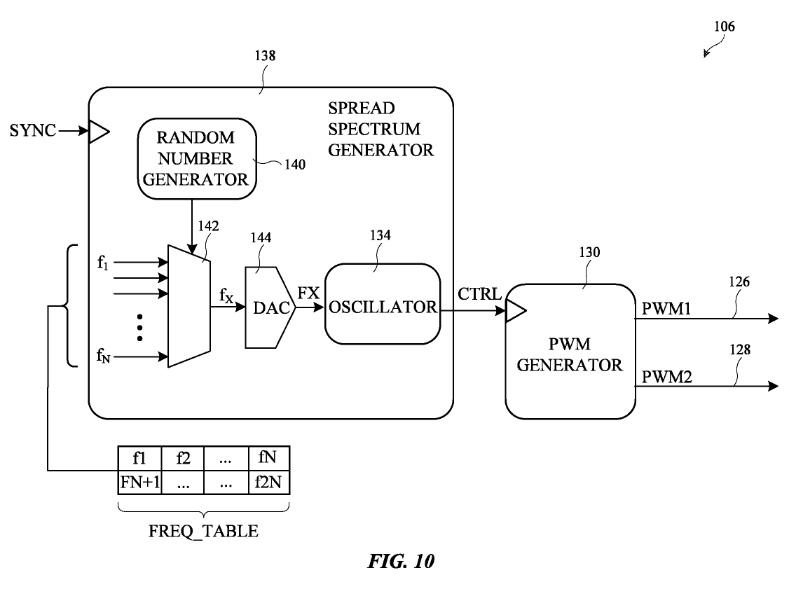

FIG. 10 is a circuit diagram showing one example of spread spectrum generator 138. In the example of FIG. 10, oscillator 134 is formed as a part of spread spectrum generator 138. This is illustrative and, if desired, oscillator 134 may be separate from spread spectrum generator 138.

As shown in FIG. 10, spread spectrum generator 138 may include digital circuitry such as a random number generator 140 (e.g., a pseudorandom number generator) and switching circuitry such as multiplexer 142. The input of multiplexer 142 may receive N different frequencies f (e.g., frequencies FA for drive signal 82) from control signal FREQ_TABLE. The output of multiplexer 142 may be coupled to the input of digital-to-analog converter (DAC) 144. The output of DAC 144 may be coupled to the input of oscillator 134. The output of oscillator 134 may be coupled to a clock input of PWM generator 130. Spread spectrum generator 138 may receive a clocking signal such as synchronization signal SYNC from clock circuitry 136 of FIG. 9 (e.g., clock 136 may synchronize control LUT 108 with spread spectrum generator 138).

In this implementation, random number generator 140 may output a multiplexer control signal and may supply the multiplexer control signal to a control input of multiplexer 142. The multiplexer control signal may control multiplexer 142 to output a selected one of the N frequencies f from control signal FREQ_TABLE to the input of DAC 144 as signal fₓ. Random number generator 140 may generate the multiplexer control signal with a randomly selected value that controls multiplexer 142 to pass a randomly selected one of the N frequencies f from control signal FREQ_TABLE to DAC 144 during a given time period. DAC 144 may convert control signal fₓfrom the digital domain to the analog domain, producing analog control signal FX. Oscillator 134 may generate control signal CTRL based on analog control signal FX and may supply control signal CTRL to the clock input of PWM generator 130. When clocked using control signal CTRL, PWM generator 130 may generate PWM control signals PWM1 and PWM2 that cause drive signal 82 to exhibit a frequency FA corresponding to the frequency identified by signal fₓ. By randomly coupling one of the N inputs of multiplexer 142 to DAC 144 over time, driver 80 may drive tint layer 42 using drive signal 82 at N different frequencies FA, where the particular frequency FA that is used for any given hopping period HP is randomly selected from the set of N different frequencies FA. This is illustrative and non-limiting. Alternatively, random number generator 140 may be replaced with control circuitry that couples different inputs of multiplexer 142 to DAC 144 according to a predetermined (deterministic or non-random) beam hopping pattern (see, e.g., the repeating pattern shown in FIG. 7). Spread spectrum generator 138 may be replaced with any desired control circuitry that controls PWM generator 130 to generate PWM control signals PWM1 and PWM2 for adjusting the PWM of drive signal 82 to cause drive signal 82 to be supplied to tint layer 42 at different frequencies FA over time while tint layer 42 remains in a steady state.

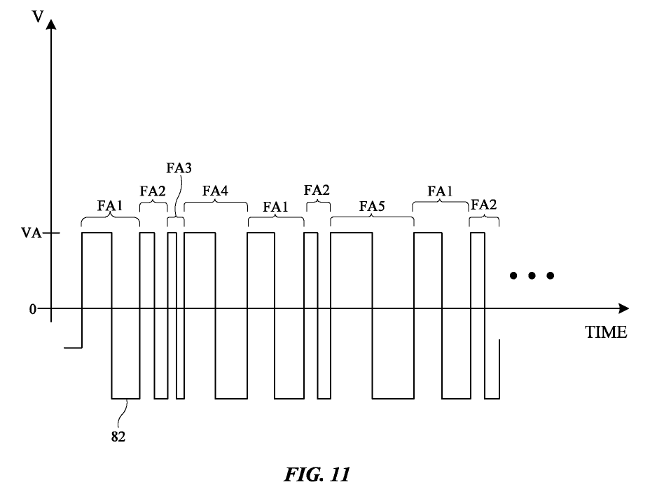

FIG. 11 is a timing diagram showing one illustrative waveform of drive signal 82 that driver 80 may supply to tint layer 42 while tint layer 42 remains in a steady state. As shown in FIG. 11, rather than hopping between N frequencies FA during a series of uniform hopping periods HP (e.g., as shown in FIG. 7), driver 80 may generate drive signal 82 at each frequency FA for a predetermined number of cycles (periods). In the example of FIG. 11, driver 80 generates drive signal 82 at each frequency FA for a single cycle per frequency (e.g., per hop in the hopping schedule).

As shown in the example of FIG. 11, driver 80 may supply drive signal 82 to tint layer 42 at frequency FA1 for one period (cycle), may then supply drive signal 82 to tint layer 42 at frequency FA2 for one period (cycle), may then supply drive signal 82 to tint layer 42 at frequency FA3 for one period (cycle), may then supply drive signal 82 to tint layer 42 at frequency FA4 for one period (cycle), may then supply drive signal 82 to tint layer 42 at frequency FA4 for one period (cycle), may then supply drive signal 82 to tint layer 42 at frequency FA1 for one period (cycle), may then supply drive signal 82 to tint layer 42 at frequency FA2 for one period (cycle), may then supply drive signal 82 to tint layer 42 at frequency FA5 for one period (cycle), may then supply drive signal 82 to tint layer 42 at frequency FA1 for one period (cycle), may then supply drive signal 82 to tint layer 42 at frequency FA2 for one period (cycle), etc. Because drive signal 82 is supplied at the same magnitude VA during each of these cycles, tint layer 42 may remain in the same steady state even as drive signal 82 hops between frequencies FA. In practice, supplying drive signal 82 at each frequency FA for at least one cycle may help to ensure that tint layer 42 remains in a stable steady state. If desired, driver 80 may supply drive signals 82 at one or more of frequencies FA for more than one cycle. Driver 80 need not supply drive signals 82 with the same number of cycles for each frequency FA.

This example is illustrative and non-limiting. If desired, driver 80 may supply drive signal 82 at each frequency FA for hopping periods HP of a predetermined duration (e.g., as shown in FIG. 7) rather than for a predetermined number of one or more cycles (e.g., as shown in FIG. 11). If desired, driver 80 may continuously adjust frequency FA across a continuous range of frequencies FA (e.g., as N approaches infinity). If desired, driver 80 may adjust the magnitude of drive signal 82 over time (e.g., to transition the tint layer between steady states).

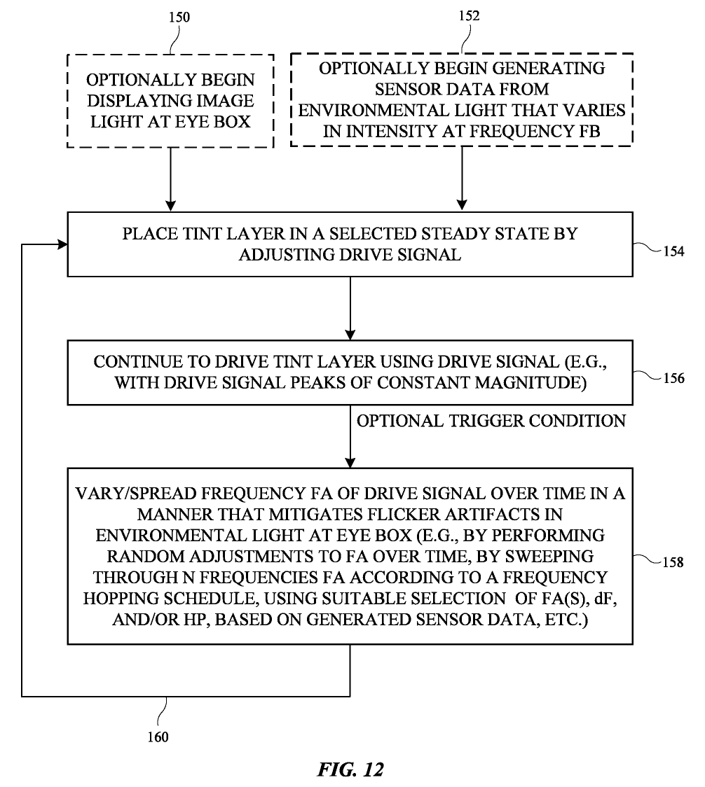

FIG. 12 is a flow chart involved in displaying images using display 20 (FIG. 1). At optional operation 150, display 20 may begin displaying image light 30 (FIG. 1) at eye box 24. Display 20 may continue to display image light 30 prior to, after, and/or concurrent with one or more of the remaining operations of FIG. 12. Operation 150 may be omitted if desired.

At optional operation 152, one or more sensors in system 10 may begin generating sensor data SENSDAT (FIG. 5) that is indicative of and/or that identifies artificial light source 86, artificial light 84, and/or frequency FB. The sensor(s) may continue to generate sensor data SENSDAT prior to, after, and/or concurrent with one or more of the remaining operations of FIG. 12. Operation 152 may be omitted if desired.

At operation 154, driver 80 may place tint layer 42 in a selected steady state (e.g., clear state M1 or dark state M2 of FIG. 4). This may involve driving tint layer 42 using drive signal 82 with pulses of uniform magnitude over time (e.g., magnitude VA of FIG. 5 while tint layer 42 is in the clear state, magnitude VB of FIG. 5 or zero volts while tint layer 42 is in the dark state, etc.).

At operation 156, driver 80 may continue to supply drive signal 82 to tint layer 42 to hold tint layer 42 in the selected steady state. Driver 80 may continue to supply drive signal 82 to tint layer 42 to hold tint layer 42 in the selected steady state while processing operation 158. If desired, processing may proceed from operation 156 to operation 158 in response to an optional trigger condition. The optional trigger condition may include, for example, the generation of sensor data SENSDAT that indicates the presence of artificial light 84 (e.g., at frequency FB) and/or other light that presents the risk of producing flicker artifacts in transmitted light 84’. Put differently, driver 80 may perform spectrum spreading on drive signal 82 in response to detection of ambient lighting conditions that would otherwise put tint layer 42 at risk of producing flicker artifacts in transmitted light 84’. In the absence of such a detection, driver 80 may continue to drive tint layer 42 with a drive signal 82 at a constant frequency FA over time, if desired. As another example, the optional trigger condition may include receipt of a user input or a software call instructing driver 80 to perform spectrum spreading. As yet another example, driver 80 may always perform spectrum spreading, in which case processing may proceed from operation 156 to operation 158 without the occurrence of a trigger condition.

At operation 158, driver 80 may perform spectrum spreading on drive signal 82 (e.g., may drive tint layer 42 using a spectrum-spread drive signal 82). This may include varying, adjusting, and/or spreading the frequency FA of drive signal 82 over time while tint layer 42 remains in the steady state (e.g., without tint layer 42 entering a transient state or switching to a different steady state). Driver 80 may, for example, vary the frequency FA of drive signal 82 in a manner that mitigates the production of flicker artifacts in the transmitted light 84’ provided to the eye box (e.g., given incident artificial light with intensity modulations at frequency FB).

Driver 80 may vary frequency FA over time (e.g., between N different frequencies FA using any combination of the techniques described herein) according to a corresponding frequency hopping schedule. The frequency hopping schedule may be predetermined or may be randomly generated (e.g., using random number generator 140 of FIG. 10). When the frequency hopping schedule is predetermined, the hopping schedule (e.g., the list of FAs, integer N, frequency gap dF, and/or hopping periods PH) may be selected such that tint layer 42 is driven in a manner that mitigates the production of flicker artifacts in transmitted light 84’. This predetermined selection may be performed in calibration or in the field (e.g., by sweeping through drive signal parameters and measuring transmitted light 84’ until flicker artifacts are minimized or no longer present, by selecting parameters that are known to minimize flicker artifacts for a given frequency FB as identified by sensor data SENSDAT, etc.). When the frequency hopping schedule is randomly generated, the random variation in frequency FA may cause tint layer 42 to output transmitted light 42’ that does not or that is statistically unlikely to contain noticeable flicker artifacts. Processing may loop back to operation 154 via path 160 as driver 80 switches tint layer 42 between different steady states.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

System 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person’s physical motions, or representations thereof, are tracked, and, in response, one or more characteristics of one or more virtual objects simulated in the CGR environment are adjusted in a manner that comports with at least one law of physics. For example, a CGR system may detect a person’s head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person’s presence within the computer-generated environment, and/or through a simulation of a subset of the person’s physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person’s eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person’s eyes. The display may utilize digital light projection, OLEDs, LEDs, µLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person’s retina. Projection systems also may be configured to project virtual objects into the physical environment, for example, as a hologram or on a physical surface.

The methods and operations described above in connection with FIGS. 1-12 may be performed by the components of system 10 using software, firmware, and/or hardware (e.g., dedicated circuitry or hardware). Software code for performing these operations may be stored on non-transitory computer readable storage media (e.g., tangible computer readable storage media) stored on one or more of the components of system 10 (e.g., storage circuitry in control circuitry 16 of FIG. 1). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of system 10 (e.g., processing circuitry in control circuitry 16 of FIG. 1, etc.). The processing circuitry may include microprocessors, application processors, digital signal processors, central processing units (CPUs), application-specific integrated circuits with processing circuitry, or other processing circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. A head-mounted display device comprising:
a tint layer that transmits light to an eye box and that is switchable between at least a first steady state and a second steady state; and
a driver that drives the tint layer using a drive signal, wherein the driver adjusts a frequency of the drive signal over time while the tint layer is in the first steady state.

2. The head-mounted display device of claim 1, wherein the driver adjusts the frequency of the drive signal between N different frequencies over time while the tint layer is in the first steady state.

3. The head-mounted display device of claim 2, wherein the N different frequencies are separated by uniform frequency gaps.

4. The head-mounted device of claim 3, wherein N is an integer between 5 and 15 and the frequency gaps are between 5 Hz and 15 Hz.

5. The head-mounted device of claim 3, wherein N is an integer between 40 and 80 and the frequency gap are between 0.5 Hz and 2 Hz.

6. The head-mounted device of claim 2, wherein the driver adjusts the frequency of the drive signal between the N different frequencies according to a predetermined frequency hopping schedule.

7. The head-mounted device of claim 2, wherein the driver adjusts the drive signal between the N different frequencies by randomly switching between the N different frequencies over time while the tint layer is in the first steady state.

8. The head-mounted device of claim 1, wherein the tint layer has a maximum transmission level and a minimum transmission level, the tint layer exhibits the maximum transmission level in the first steady state, and the tint layer exhibits the minimum transmission level in the second steady state.

9. The head-mounted device of claim 1, wherein drive signal comprises a binary square wave having a series of pulses and wherein the pulses have a constant peak magnitude while the tint layer is in the first steady state.

10. The head-mounted device of claim 1, further comprising:
a waveguide that propagates image light via total internal reflection;
an optical coupler on the waveguide that redirects the image light out of the waveguide and towards the eye box, wherein the tint layer overlaps the optical coupler and transmits the light towards the eye box through the optical coupler; and
a sensor configured to generate sensor data based on the light, wherein the driver is configured to begin adjusting the frequency of the drive signal in response to the sensor data indicating that the second light contains intensity modulations at an additional frequency that is associated with a subharmonic flickering artifact in the second light after transmission of the second light by the tint layer.

11. The head-mounted device of claim 1, wherein the driver comprises:
a regulator communicatively coupled to a first terminal on a first electrode of the tint layer and to a second terminal on a second electrode of the tint layer;
a first transistor communicatively coupled to the first terminal;
a second transistor communicatively coupled to the second terminal;
a pulse width modulation (PWM) generator communicatively coupled to a gate terminal of the first transistor and a gate terminal of the second transistor; and
a spread spectrum generator that controls the PWM generator to pulse the gate terminals of first and second transistors to drive the tint layer with the drive signal at the frequency.

12. A method of operating a display comprising:
with a driver, supplying a tint layer with a drive signal that configures the tint layer to exhibit a transmission level;
with the tint layer, transmitting environmental light to an eye box while the tint layer exhibits the transmission level; and
with the driver, mitigating production of a flicker artifact in the environmental light transmitted by the tint layer by adjusting a frequency of the drive signal over time while the tint layer exhibits the transmission level, wherein the flicker artifact is associated with a difference between the frequency of the drive signal and a frequency of an intensity modulation in the environmental light.

13. The method of claim 12, wherein adjusting the frequency of the drive signal comprises switching the drive signal between a set of N different frequencies over time while the tint layer exhibits the transmission level.

14. The method of claim 13, wherein adjusting the frequency of the drive signal further comprises:
outputting the drive signal at each frequency in the set of N different frequencies for at least one respective cycle of the drive frequency.

15. The method of claim 13, wherein adjusting the frequency of the drive signal further comprises:
outputting the drive signal at each frequency in the set of N different frequencies during a respective time period, each of the respective time periods having a same duration.

16. The method of claim 12, wherein adjusting the frequency of the drive signal comprises randomly varying the frequency of the drive signal over time while the tint layer exhibits the transmission level.

17. The method of claim 12, wherein the drive signal comprises a binary square wave, wherein the transmission level comprises a maximum transmission level of the tint layer, and the method further comprises:
with the driver, configuring the tint layer to exhibit a minimum transmission level of the tint layer by reducing a magnitude of the binary square wave; and
with the tint layer, transmitting at least some of the environmental light to the eye box through the waveguide while the tint layer exhibits the minimum transmission level.

18. The method of claim 12, further comprising:
with a waveguide, propagating image light via total internal reflection;
with an optical coupler on the waveguide, redirecting the image light out of the waveguide and towards the eye box;
with the optical coupler, transmitting the environmental light from the tint layer towards the eye box;
with a sensor, generating sensor data based on the environmental light; and
with the driver, adjusting the frequency of the drive signal over time based on the sensor data.

19. An electronic device comprising:
a tint layer that transmits environmental light; and
a driver that drives the tint layer using a drive signal, wherein the driver includes
a pulse width modulation (PWM) generator communicatively coupled to first and second electrodes of the tint layer, and
a spread spectrum generator communicatively coupled to the PWM generator, wherein the spread spectrum generator controls the PWM generator to randomly vary a frequency of the drive signal over time.

20. The electronic device of claim 19, further comprising:
an optical system that propagates image light, wherein the tint layer transmits the environmental light through the optical system and wherein the spread spectrum generator comprises:
an oscillator having an output communicatively coupled to a clock input of the PWM generator;
a digital-to-analog converter (DAC) communicatively coupled to an input of the oscillator;
a multiplexer having inputs that each receive a respective frequency from a set of N different frequencies for the drive signal and having an output communicatively coupled to an input of the DAC; and
a random number generator communicatively coupled to a control input of the multiplexer.
